(19) United States
(12) Patent Application Publication
(10) Pub. No.: US 2024/0387848 A1
(43) Pub. Date: Nov. 21, 2024

(54) COMPOSITE ION-EXCHANGE MEMBRANES FOR FLOW BATTERIES

(71) Applicant: ESS TECH, INC., Wilsonville, OR (US)

(72) Inventors: Yan Wu, Tigard, OR (US); Karana Dunn, Wilsonville, OR (US); Yang Song, Durham, NC (US)

(21) Appl. No.: 18/612,325

(22) Filed: Mar. 21, 2024

Related U.S. Application Data
(60) Provisional application No. 63/502,713, filed on May 17, 2023.

(51) Int. Cl. H01M 8/1039; H01M 8/04186; H01M 8/10; H01M 8/106; H01M 8/18

(52) U.S. Cl. CPC H01M 8/1039; H01M 8/04186; H01M 8/106; H01M 8/188; H01M 2008/1095; H01M 2300/0071; H01M 2300/0082; H01M 2300/0094

(57) ABSTRACT

Membranes for flow battery cells are provided herein. In one example, a membrane for a flow battery system includes a microporous substrate having a first surface and a second surface, opposite the first surface, and a coating of ion-conducting polymer on the first surface and the second surface, wherein one or more pores of the microporous substrate are at least partially filled with the ion-conducting polymer.

### CROSS REFERENCE TO RELATED APPLICATIONS

The present application claims priority to U.S. Provisional Application No. 63/502,713, titled “COMPOSITE ION-EXCHANGE MEMBRANES FOR FLOW BATTERIES,” and filed May 17, 2023, the entire contents of which is hereby incorporated by reference for all purposes.

### FIELD

The present description relates generally to systems and methods for a composite membrane of a flow battery.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. Many redox flow batteries include a selective membrane that separates the positive and negative sides of each battery. As such, only a particular subset of ions may pass through the membrane and transfer charge between the positive and negative sides of the flow battery. To support this selectivity, an ion-conducting coating may be included on one side of the membrane. Even so, poor ion selectivity, low voltaic efficiency, and delamination of the membrane still limit battery performance.

Previous attempts to address the above issues have included casting an ion-selective coating onto the membrane during fabrication. A casted ion-selective membrane has increased mechanical strength as compared to a free-standing ion-selective membrane.

However, the inventors herein have recognized issues with the above ion-selective membranes. Delamination between the membrane and the casted ion-selective coating may still occur under certain operating conditions. In some examples, such delamination may occur due to an unmatched hydration state and ion transport properties between the membrane and the ion-selective coating.

In one example, the issues described above may be at least partially addressed by a composite membrane for a flow battery system including a microporous substrate having a first surface and a second surface, opposite the first surface, and a coating of ion-conducting polymer on the first surface and the second surface, wherein one or more pores of the microporous substrate are at least partially filled with the ion-conducting polymer. Impregnation of the microporous substrate with ion-conducting polymer may bring the hydration state of the microporous membrane closer to the hydration state of the coating of ion-conducting polymer and decrease delamination between the substrate and the coating. Additionally, a microporous substrate with a coating of ion-conducting polymer on both sides (e.g., a double coating) may have increased ion-selectivity when compared to a microporous membrane with a coating of ion-conducting polymer on only one side.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery;

FIG. 2 shows a cross section of an example composite membrane;

FIG. 3 shows a method for fabricating the composite membrane of FIG. 2;

FIG. 4 shows an example fabrication process for the composite membrane of FIG. 2; and

FIG. 5 shows the voltage over time of a cell with a composite membrane during a full charge and discharge.

### DETAILED DESCRIPTION

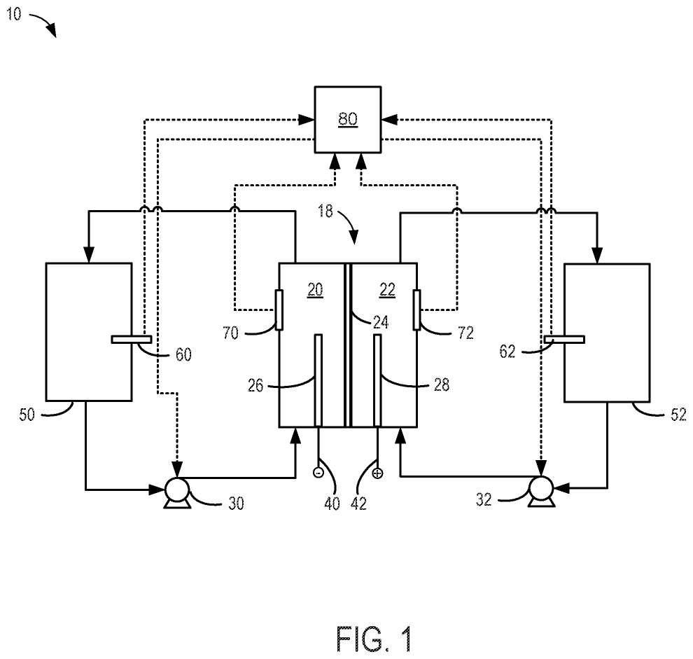

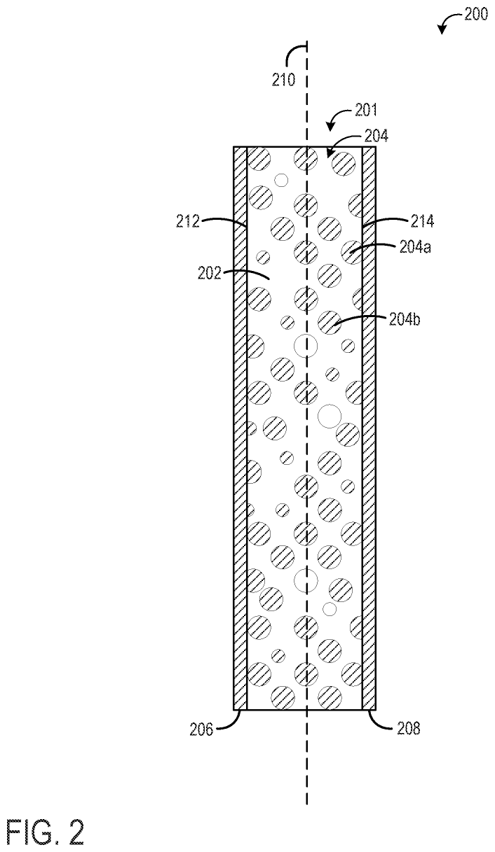

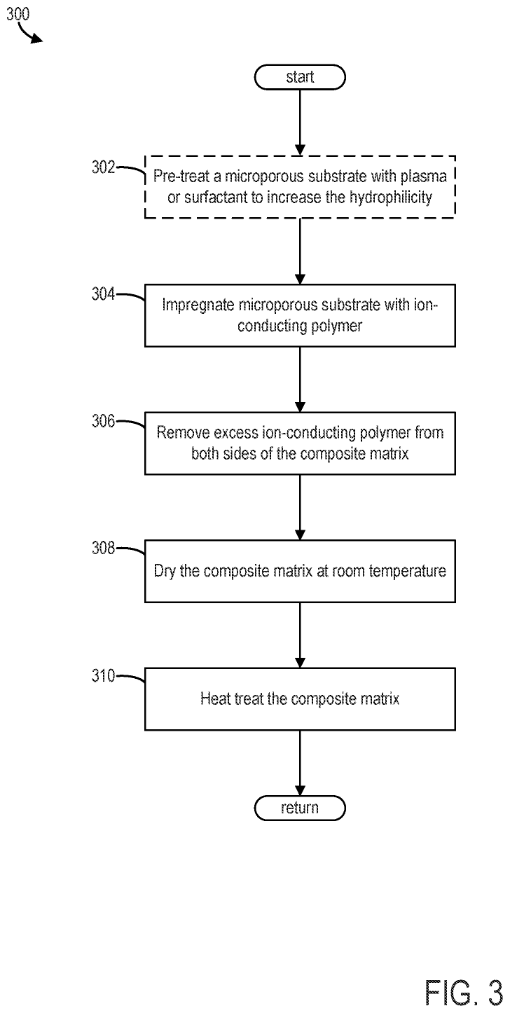

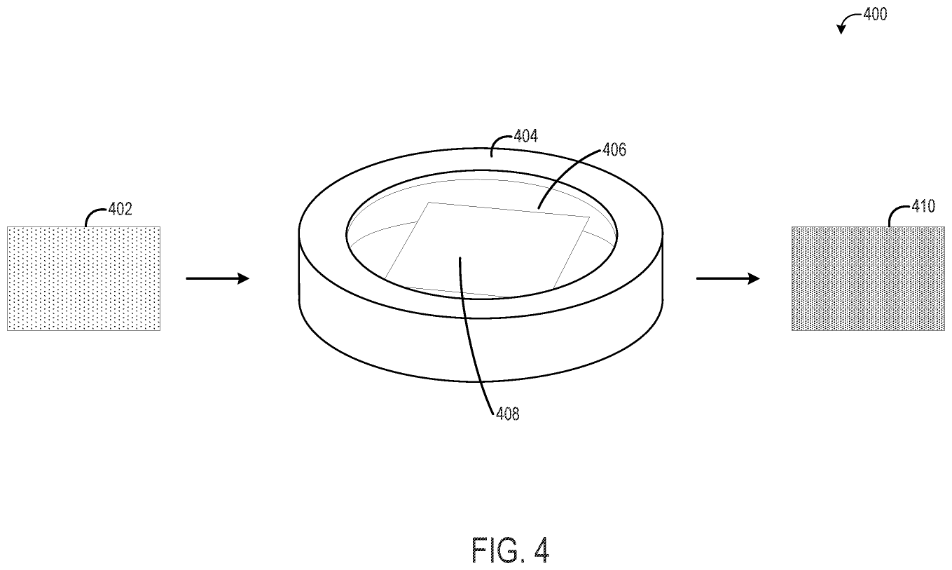

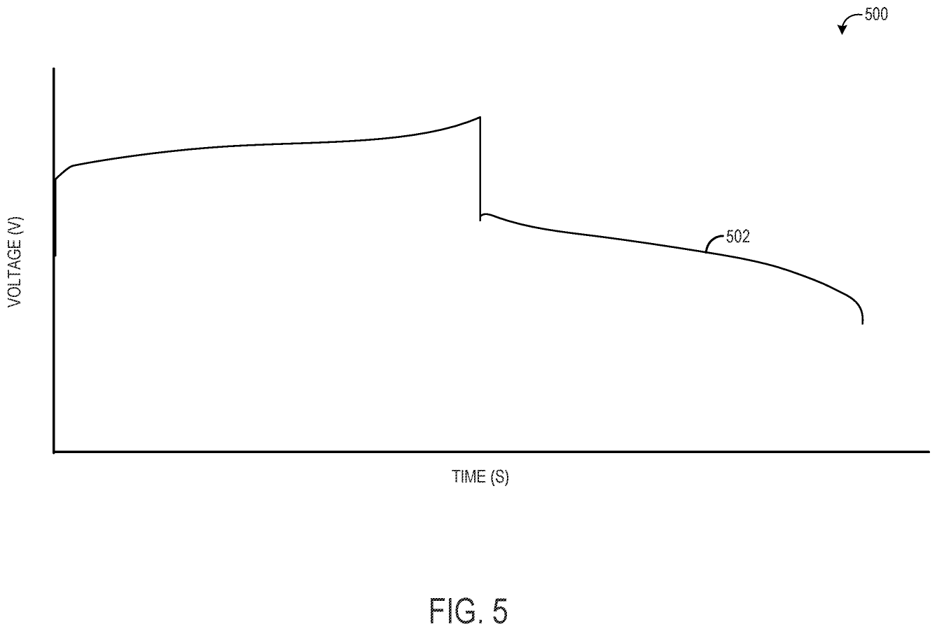

The following descriptions relates to systems and methods for a composite membrane of a flow battery. An example of a redox flow battery system including a membrane is shown in FIG. 1. The composite membrane may include a microporous substrate and ion-conducting polymer. The ion-conducting polymer may impregnate and coat both sides of the microporous substrate as shown in a cross section of the composite matrix in FIG. 2. The composite matrix may be fabricated by pressing or soaking ion-conducting polymer into a microporous substrate, as detailed in FIG. 3. An example of the fabrication process of FIG. 3 is illustrated in FIG. 4. Cells including the composite membrane of FIG. 2 may perform with a coulombic efficiency of 90% with a full charge and discharge, such as the charge and discharge shown in FIG. 5.

Referring now to FIG. 1, operation of a redox flow battery 10 is described. The reduction-oxidation (redox) flow battery is an electrochemical storage device that stores energy in a chemical form and converts the stored chemical energy to an electrical form via spontaneous reversible redox reactions. The reaction in a flow battery is reversible, so conversely, the dispensed chemical energy can be restored by the application of an electrical current inducing the reverse redox reactions. A single redox flow battery cell 18 generally includes a negative electrode compartment 20, a separator 24, such as a composite matrix, and a positive electrode compartment 22. The negative electrode compartment 20 may comprise a negative electrode 26, and a negative electrolyte comprising electro-active materials. The positive electrode compartment 22 may comprise a positive electrode 28, and a positive electrolyte comprising electro-active materials. In some examples, multiple redox flow battery cells 18 may be combined in series or parallel to create a higher voltage or current in a redox flow battery system. Electrolytes are typically stored in tanks external to the cell, and are pumped via pumps 30 and 32 through the negative electrode compartment 20 side and the positive electrode compartment 22 side of the battery, respectively. In the example of FIG. 1, the positive electrolyte is stored at a positive electrolyte source 52, which may comprise an external positive electrolyte tank, and the negative electrolyte is stored at a negative electrolyte source 50, which may comprise a second external tank. The separator 24 may comprise an electrically insulating ionic conducting barrier which prevents bulk mixing of the positive electrolyte and the negative electrolyte while allowing conductance of specific ions therethrough. For example, the separator 24 may comprise an ion-exchange coating or a microporous membrane.

When a charge current is applied to the battery terminals 40 and 42, the positive electrolyte is oxidized (lose one or more electrons) at the positive electrode 28, and the negative electrolyte is reduced (gain one or more electrons) at the negative electrode 26. During battery discharge, reverse redox reactions occur on the electrodes. In other words, the positive electrolyte is reduced (gain one or more electrons) at the positive electrode 28, and the negative electrolyte is oxidized (lose one or more electrons) at the negative electrode 26. The electrical potential difference across the battery is maintained by the electrochemical redox reactions in the positive electrode compartment 22 and the negative electrode compartment 20, and can induce a current through a conductor while the reactions are sustained. The amount of energy stored by a redox battery is limited by the amount of electro-active material available in electrolytes for discharge, depending on the total volume of electrolytes and the solubility of the electro-active materials.

During operation of a redox flow battery system, sensors and probes may monitor and control chemical properties of the electrolyte such as electrolyte pH, concentration, state of charge, and the like. For example, sensors 62 and 60 maybe be positioned to monitor positive electrolyte and negative electrolyte conditions at the positive electrolyte source 52 and the negative electrolyte source 50, respectively. As another example, sensors 72 and 70 may monitor positive electrolyte and negative electrolyte conditions at the positive electrode compartment 22 and the negative electrode compartment 20, respectively. Sensors may be positioned at other locations throughout the redox flow battery system to monitor electrolyte chemical properties and other properties. For example, a sensor may be positioned in an external acid tank (not shown) to monitor acid volume or pH of the external acid tank, wherein acid from the external acid tank is supplied via an external pump (not shown) to the redox flow battery system in order to reduce precipitate formation in the electrolytes. Additional external tanks and sensors may be installed for supplying other additives to the redox flow battery system. Sensor information may be transmitted to a controller 80 which may in turn actuate pumps 30 and 32 to control electrolyte flow through the redox flow battery cell 18, or to perform other control functions, as an example. In this manner, the controller 80 may be responsive to, one or a combination of sensors and probes.

Hybrid flow batteries are redox flow batteries that are characterized by the deposit of one or more of the electro-active materials as a solid layer on an electrode. Hybrid batteries may, for instance, include a chemical that plates via an electrochemical reaction as a solid on a substrate throughout the battery charge process. During battery discharge, the plated species may ionize via an electrochemical reaction, becoming soluble in the electrolyte. In hybrid battery systems, the charge capacity (e.g., amount of energy stored) of the redox battery may be limited by the amount of metal plated during battery charge and may accordingly depend on the efficiency of the plating system as well as the available volume and surface area available for plating.

In a hybrid flow battery system, the negative electrode 26 may be referred to as the plating electrode and the positive electrode 28 may be referred to as the redox electrode. The negative electrolyte within the plating side (e.g., negative electrode compartment 20) of the battery may be referred to as the plating electrolyte and the positive electrolyte on the redox side (e.g. positive electrode compartment 22) of the battery may be referred to as the redox electrolyte.

Anode refers to the electrode where electro-active material loses electrons and cathode refers to the electrode where electro-active material gains electrons. During battery charge, the positive electrolyte gains electrons at the negative electrode 26; therefore, the negative electrode 26 is the cathode of the electrochemical reaction. During discharge, the positive electrolyte loses electrons; therefore, the negative electrode 26 is the anode of the reaction. Accordingly, during charge, the negative electrolyte and negative electrode may be respectively referred to as the catholyte and cathode of the electrochemical reaction, while the positive electrolyte and the positive electrode may be respectively referred to as the anolyte and anode of the electrochemical reaction. Alternatively, during discharge, the negative electrolyte and negative electrode may be respectively referred to as the anolyte and anode of the electrochemical reaction, while the positive electrolyte and the positive electrode may be respectively referred to as the catholyte and cathode of the electrochemical reaction.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻↔Fe⁰−0.44V(negative electrode) (1)

2Fe²⁺↔2Fe³⁺+2e⁻+0.77V(positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as the positive electrolyte source 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as the negative electrolyte source 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese (II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Referring now to FIG. 2, a schematic illustration of a cross-section of a composite matrix 200 is illustrated. The composite matrix 200 may be an example of a membrane for a flow battery, such as the separator 24 of FIG. 1. The composite matrix may include a microporous substrate 201, comprising a substrate body 202 and a plurality of pores 204, including a first pore 204a, a second pore 204b, etc. The microporous substrate 201 may have a first surface 212 and a second surface 214, which is opposite to the first surface 212 relative to an axis 210. Additionally, the composite matrix 200 may include a first coating 206 on the first surface 212 and a second coating 208 on the second surface 214.

The microporous substrate 201 may be polyethylene, polypropylene, expanded polytetrafluoroethylene, polyethylene-terephthalate, or another suitable porous material. Additionally, the microporous substrate 201 may include additional components, such as SiO₂. In some examples, the microporous substrate 201 may be made from different sulfonated copolymers or polymers with sulfonated groups grafted on their pore walls such as crystalline poly(ether ether ketone) or sulfonated poly(ether ether ketone). In some examples, the microporous substrate 201 may have a thickness in a range of 10-300 microns.

The first coating 206 and the second coating 208 may be an ion-conducting polymer, such as perfluorosulfonated ionomer, sulfonated block polymer, or another suitable ion-selective material. The first coating 206 may be chemically coupled to the first surface 212 of the microporous substrate 201. Similarly, the second coating may be chemically coupled to the second surface 214 of the microporous substrate 201. The first coating 206 and the second coating 208 may be comprised of the same material. In some examples, each of the first coating 206 and the second coating 208 may have a thickness in a range of 1-100 microns.

The plurality of pores 204 may be randomly positioned throughout the substrate body 202 and may vary in pore size (e.g., diameter) and shape. It is to be appreciated that the composite matrix 200 shown in FIG. 2 is schematic and that more or fewer pores having larger or smaller pore sizes than illustrated with a greater variation in pore size may be included in the substrate body 202 without departing from the scope of this disclosure. In some examples, 10-100% of the pores in the plurality of pores 204 may each be at least partially filled with an ion-conducting polymer, such as the ion-conducting polymer of the first coating 206 and the second coating 208. Each pore in the plurality of pores 204 that is at least partially filled with an ion-conducting polymer may have 10-100% of its internal volume filled by the ion-conducting polymer. As such, the plurality of pores 204 may cause the hydration state and ion transfer properties of the microporous substrate 201 to more closely match the hydration state and ion transfer properties of the first coating 206 and the second coating 208. In this way, when the plurality of pores 204 are impregnated with an ion-conducting polymer, delamination between the microporous substrate 201 and the first and second coatings may decrease.

In some examples, the microporous substrate 201 may be treated with plasma or surfactant to change the hydrophilicity of the microporous substrate 201. By increasing the hydrophilicity of the microporous substrate 201, an ion-conducting polymer may more easily fill the plurality of pores 204 and coat the first surface 212 and the second surface 214.

Thus, a membrane for a flow battery as described above with respect to FIG. 2 may include a plurality of layers. The plurality of layers may be separate, non-overlapping layers and include an inner layer comprising a microporous substrate. The microporous substrate may include a substrate body and a plurality of pores. The microporous substrate (e.g., the substrate body) may be comprised of polyethylene, polypropylene, expanded polytetrafluoroethylene, polyethylene-terephthalate, or another suitable porous material, as explained above. The plurality of pores of the microporous substrate may be filled or at least partially filled with an ion-conducting polymer, such as perfluorosulfonated ionomer, sulfonated block polymer, or another suitable ion-selective material, as explained above. The plurality of layers may further include a first outer layer and a second outer layer each comprised of the ion-conducting polymer (e.g., the same ion-conducting polymer as the inner layer). The inner layer may be sandwiched between the first outer layer and the second outer layer, such that the inner layer is directly coupled to the first outer layer on a first side of the inner layer and directly coupled to the second outer layer on a second side of the inner layer. Each of the first outer layer and the second outer layer may be comprised only of the ion-conducting polymer and may not include the substrate body. In this way, each layer of the plurality of layers may include the ion-conducting polymer and only the inner layer includes the substrate body.

Turning now to FIG. 3, a flowchart of a method 300 of fabricating a composite matrix is shown. The composite matrix may be similar to the composite matrix 200 of FIG. 2 and may be used in a flow battery, such as the redox flow battery 10 of FIG. 1. Method 300 may be carried out prior to installing the composite matrix into a flow battery to act as a membrane, such as the separator 24 of FIG. 1.

At 302, method 300 may optionally include pre-treating a microporous substrate, such as polyethylene, polypropylene, expanded polytetrafluoroethylene, polyethylene-terephthalate, or another suitable porous material (e.g., similar to the microporous substrate 201 of FIG. 2) with plasma or surfactant to increase the hydrophilicity of the microporous substrate. Increased hydrophilicity may increase the amount of ion-conducting polymer that is absorbed by the microporous matrix. In some examples, it may be beneficial to pre-treat the microporous substrate with plasma or surfactant to increase its hydrophilicity. In other examples, the microporous substrate may already be sufficiently hydrophilic and a pre-treatment with plasma or surfactant may not be beneficial. In some examples, the microporous substrate may have a thickness of 110 microns.

At 304, method 300 includes impregnating the microporous substrate with an ion-conducting polymer. For example, the impregnating may include soaking the microporous substrate in the ion-conducting polymer. In some examples, the ion-conducting polymer may be a sulfonated block copolymer, such as NEXAR, a perfluorosulfonated ionomer, or another suitable ion-selective material (e.g., similar to the ion-conducting polymer of FIG. 2). In some examples, the ion-conducting polymer may be dissolved in a solvent, such as toluene/1-propanol.

In some examples, the microporous substrate may be submerged in a container of the ion-conducting polymer solution. The microporous substrate may be submerged in the container of ion-conducting polymer for a suitable amount of time, such as 30 seconds, and in some examples may be placed under vacuum and/or subject to sonication. The ion-conducting polymer may infiltrate the pores of the microporous substrate, thereby at least partially filling the pores of the microporous substrate. Further, the ion-conducting polymer may cling to the surfaces of the microporous substrate.

At 306, method 300 includes removing the impregnated microporous substrate (e.g., a composite matrix) from the container of ion-conducting polymer and removing excess ion-conducting polymer from both the first side and the second side of the composite matrix to reach a target coating thickness. In doing so, a layer of ion-conducting polymer may remain of both the first side and the second side of the composite matrix. The layer of ion-conducting polymer remaining of both the first side and the second side may have a thickness in a range of 1-25 microns. In some examples, the ion-conducting polymer may be scraped off of the composite matrix using a doctor blade with a set height, which may result in a relatively uniform thickness of the ion-conducting polymer coating. In other examples, the ion-conducting polymer may be scraped off of the composite matrix using another suitable hand tool or a machine.

At 308, method 300 includes drying the composite matrix at room temperature (e.g., 20° C.). In this way, the ion-conducting polymer that is coating both sides of the composite matrix may dry and couple to the microporous substrate. The amount of time that the composite matrix dries at room temperature may depend on the microporous substrate and/or the ion-conducting polymer. In one non-limiting example, the composite matrix may be dried at room temperature overnight (e.g., 8-12 hours).

At 310, method 300 includes heat treating the composite matrix. As such, the composite matrix may cure and be ready for utilization within a flow battery. In some examples, the heat treatment of the composite matrix may occur by an oven, an incubator, or another suitable heat source. The amount of time that the composite matrix is heat-treated may depend on the microporous substrate and/or the ion-conducting polymer. In one non-limiting example, the dried composite matrix may be heat-treated in an oven at 130° C. for 30 minutes.

Turning now to FIG. 4, an example fabrication process 400 for fabricating a composite matrix 410 is schematically illustrated. The fabrication process 400 may be carried out according to the method 300 of FIG. 3. The example fabrication process 400 includes obtaining a microporous substrate 402. The microporous substrate 402 may be a Celgard 5550 microporous polypropylene sheet or another suitable substrate such as polyethylene, polypropylene, expanded polytetrafluoroethylene, or polyethylene-terephthalate (e.g., similar to the microporous substrate 201 of FIG. 2). The fabrication process 400 may include submerging the microporous substrate 402 in a volume of an ion-conducting polymer 406, which may be housed in a container 404, where the container 404 may be at least partially filled with the ion-conducting polymer 406. The ion-conducting polymer 406 may be NEXAR 9204-DX5 solution or another suitable ion-conducting polymer such as a perfluorosulfonated ionomer (e.g., similar to the ion-conducting polymer of FIG. 2). The microporous substrate 402 may be soaked in the ion-conducting polymer 406 until the microporous substrate 402 is coated with the ion-conducting polymer and the pores of the microporous substrate 402 are impregnated with the ion-conducting polymer to form a composite matrix 408. The composite matrix 408 may be removed from the container 404 and the ion-conducting polymer 406.

Excess of the ion-conducting polymer 406 (e.g., excess ionomer dispersion) may be removed (e.g., scraped off) by a doctor blade from both sides of the composite matrix 408 to create a 5-15 microns thick coating of the ion-conducting polymer. Any ion-conducting polymer 406 that is still remaining on the sides of the composite matrix 408 may form a double-sided coating similar to the first coating 206 and the second coating 208 of FIG. 2. The composite matrix 408 may be dried at room temperate overnight. Additionally, after drying at room temperature overnight, the composite matrix 408 may be heat treated at 130 degrees Celsius in an oven for thirty minutes.

FIG. 5 shows a graph 500 of the voltage over time of a cell (e.g., a battery) containing a composite matrix, such as the composite matrix 200 of FIG. 2. The voltage may be measured over time and plotted as line 502 during a full charge and discharge of the cell, such as the redox flow battery 10 of FIG. 1. Cell performance may be tested in a 50 cm² cell. The coulombic efficiency of a cell with a composite matrix membrane, such as the composite matrix 200 of FIG. 2, may be at least 90%. For example, as shown in FIG. 5, the total charge extracted from the cell (e.g., from when the charging circuit is opened to the end of the discharge cycle) to the total charge put into the cell may be about 90%. Through optimization of coating uniformity, type of substrate and ion selective polymer, the efficiencies of a cell with a composite matrix membrane, such as the composite matrix 200 of FIG. 2, can be further improved and may be comparable to cells with other state-of-the-art membranes.

Thus, a composite membrane may provide separation of the positive and negative sides of a flow battery and allow certain ions to transfer as charge carriers during operation. The composite membrane may include a microporous substrate and an ion-conducting polymer, where the ion-conducting polymer coats both sides of the microporous substrate and fills one or more pores of the microporous substrate. Impregnation of the microporous substrate with ion-conducting polymer may provide both mechanical integrity and ion-selectivity to the composite membrane. Additionally, the ion-conducting polymer within the microporous substrate may bring the hydration state of the microporous membrane closer to the hydration state of the coating of ion-conducting polymer and decrease delamination between the substrate and the coating.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A membrane for a flow battery system, comprising:
a microporous substrate having a first surface and a second surface, opposite the first surface, the microporous substrate having a substrate body and plurality of pores; and
a coating of ion-conducting polymer on the first surface and the second surface, wherein one or more pores of the plurality of pores of the microporous substrate are at least partially filled with the ion-conducting polymer.

2. The membrane of claim 1, wherein the substrate body comprises polyethylene, polypropylene, expanded polytetrafluoroethylene, or polyethylene-terephthalate.

3. The membrane of claim 1, wherein the substrate body comprises sulfonated copolymers or polymers with sulfonated groups grafted on pore walls of the microporous substrate.

4. The membrane of claim 1, wherein the substrate body includes SiO₂.

5. The membrane of claim 1, wherein the ion-conducting polymer includes perfluorosulfonated ionomer or sulfonated block polymer.

6. The membrane of claim 1, wherein at least 10% of pores of the plurality of pores of the microporous substrate are at least partially filled with the ion-conducting polymer.

7. A flow battery cell, comprising:
a negative electrode compartment;
a positive electrode compartment; and
a composite matrix membrane separating the negative electrode compartment and the positive electrode compartment, the composite matrix membrane comprising a microporous substrate having a first surface and a second surface, opposite the first surface, and a coating of ion-conducting polymer on the first surface and the second surface, wherein one or more pores of a plurality of pores of the microporous substrate are at least partially filled with the ion-conducting polymer.

8. The flow battery cell of claim 7, wherein the negative electrode compartment includes a negative electrode and a negative electrolyte and the positive electrode compartment includes a positive electrode and a positive electrolyte.

9. The flow battery cell of claim 7, wherein the ion-conducting polymer includes perfluorosulfonated ionomer or sulfonated block polymer.

10. The flow battery cell of claim 7, wherein the microporous substrate comprises polyethylene, polypropylene, expanded polytetrafluoroethylene, or polyethylene-terephthalate.

11. The flow battery cell of claim 7, wherein the microporous substrate comprises sulfonated copolymers or polymers with sulfonated groups grafted on pore walls of the microporous substrate.

12. The flow battery cell of claim 7, wherein the microporous substrate includes SiO₂.

13. The flow battery cell of claim 7, wherein at least 10% of pores of the plurality of pores of the microporous substrate are at least partially filled with the ion-conducting polymer.

14. A method for manufacturing a composite matrix for a flow battery cell, comprising:
impregnating a microporous substrate with an ion-conducting polymer; and
forming a coating of the ion-conducting polymer on both a first side and a second side, opposite the first side, of the microporous substrate to form the composite matrix.

15. The method of claim 14, wherein impregnating the microporous substrate with the ion-conducting polymer comprises submerging the microporous substrate in a volume of the ion-conducting polymer, and wherein forming the coating of the ion-conducting polymer on both the first side and the second side of the microporous substrate comprises removing the impregnated microporous substrate from the volume of the ion-conducting polymer and removing excess ion-conducting polymer from each of the first side and the second side until a target coating thickness is reached.

16. The method of claim 15, further comprising drying and heat-treating the composite matrix.

17. The method of claim 14, wherein the ion-conducting polymer comprises perfluorosulfonated ionomer or sulfonated block polymer.

18. The method of claim 14, wherein the microporous substrate comprises polyethylene, polypropylene, expanded polytetrafluoroethylene, polyethylene-terephthalate, sulfonated copolymers, or polymers with sulfonated groups grafted on their pore walls.
